(19) United States
(12) Patent Application Publication
(10) Pub. No.: US 2014/0152421 A1
(43) Pub. Date: Jun. 5, 2014

(54) NEAR FIELD COMMUNICATION BASED KEY CONTROL SERVICE

(71) Applicant: Cellco Partnership D/B/A Verizon Wireless, (US)

(72) Inventors: Carlos A. CAZANAS, Bethleham, PA (US); Victor M. PAGAN, Breinigsville, PA (US)

(73) Assignee: CELLCO PARTNERSHIP D/B/A VERIZON WIRELESS, Basking Ridge, NJ (US)

(21) Appl. No.: 13/693,828

(22) Filed: Dec. 4, 2012

(51) Int. Cl. E05B 39/00

(52) U.S. Cl. CPC E05B 39/00
USPC 340/5.32

(57) ABSTRACT

Systems and techniques for providing a near field communication (NFC) based key control service and automated notification system are provided for automatically reporting unauthorized or restricted uses of an NFC-enabled physical key to the primary user or owner of the key via a communication network. An NFC reader is configured to communicate with a server of the NFC based key control service via a network in order to report attempted violations of one or more use restrictions defined for the key, as detected by the NFC reader when the NFC tag embedded within the key is located near a third-party device associated with a restricted use of the key.

### BACKGROUND

Traditional methods for restricting the unauthorized duplication of a physical key used to access a specific piece of real or personal property, e.g., a building or vehicle, owned by the user typically involve various manual steps that must be performed by the user or various third-parties in order to enforce the restriction. For example, a key marked “Do Not Duplicate” (or DND key) is commonly used to restrict a third-party locksmith or retail store offering key copying services against making duplicates or reproductions of the physical key. However, as there is generally no direct legal sanction for violating such a restriction, e.g., by duplicating a DND key without prior authorization from the owner of they key, the DND mark on the key only serves as a passive deterrent against key duplication and relies heavily on unknown third-parties to honor the DND restriction. Even if such a third-party were to honor the restriction by refusing to make a copy of the key or requesting authorization from the original manufacturer or locksmith who produced the original key, the current owner of the key may never learn of the attempted violation of the key duplication restriction. Consequently, conventional solutions for controlling a third-party's use of a physical key provide little security for key owners against unauthorized or restricted uses of the physical key.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 illustrates an exemplary communication system offering a variety of communication services, including communications for a near field communication (NFC) based key control service.

FIG. 2 is a block diagram illustrating an exemplary system for automatically notifying a user of an unauthorized or restricted use of a physical key having an embedded NFC tag via an interface of the NFC based key control service at the user's computing device.

FIG. 3 is a flowchart of an exemplary method for automatically notifying a user of attempted violations of key use restrictions configured by the user via an interface of an NFC based key control service.

FIG. 4 illustrates an exemplary NFC reader communicatively coupled to an exemplary NFC target via a near field.

FIG. 5 is a simplified functional block diagram of an example computer that may be configured as a host or server.

FIG. 6 is a simplified functional block diagram of an example personal computer or other workstation or terminal device.

### DETAILED DESCRIPTION OF PREFERRED EMBODIMENTS

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

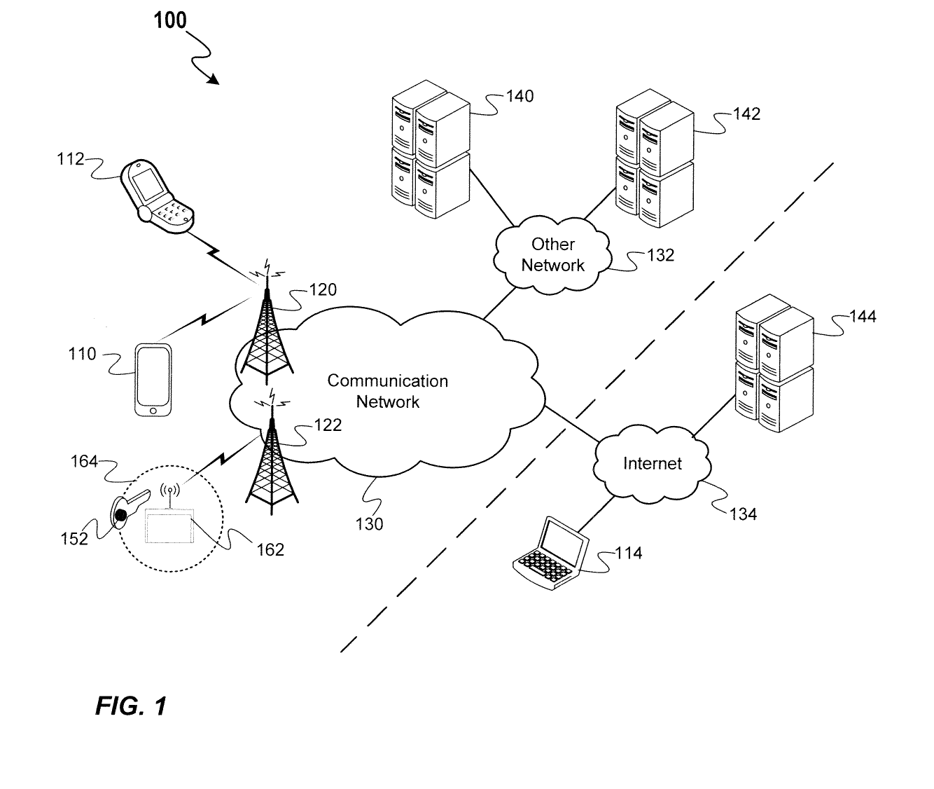

The various examples discussed below and as shown in FIGS. 1-6 relate to an automated physical key control service based on near field communication (NFC) technology embedded within a physical key. As will be described in further detail below, such an NFC based key control service functions as an automated notification system for automatically reporting unauthorized or restricted uses of the physical key to the primary user or owner of the key via a communication network. The terms “key” and “physical key” are used interchangeably herein to refer to a physical device or instrument inserted into a key hole of a mechanical lock or fastening device and used to operate the lock, e.g., by rotating the physical key in a certain direction to unlock or release the fastening device to gain access to an item of real or personal property, e.g., a building or vehicle that may be owned or managed by the primary user of the key. This does not include keycards used to operate electronic locks or keycard readers for accessing, for example, a hotel room or secured areas of an office building. For purposes of monitoring and controlling restricted or unauthorized uses of the physical key, the key may be modified to include an NFC tag or microchip. Such an “NFC-enabled key” has the NFC tag or chip embedded within the physical key. As will be described in further detail below, the embedded NFC tag may be detected by an NFC reader device when the key (or NFC tag embedded within the key) is within a predetermined proximity of the NFC reader device.

In an example, the NFC tag embedded within the physical key serves as a passive NFC target that communicates with an NFC reader or initiator device when the key and NFC tag are within a predetermined proximity or distance range of the NFC reader/initiator. The predetermined distance range may be based on, for example, the size of an electromagnetic field or “near field” actively generated by the NFC reader. However, it should be noted that the techniques described herein are not intended to be limited to such passive NFC targets and that these techniques may be applied to active NFC target devices as well. Further, the NFC target may be implemented using, for example, a separate device that is securely attached to a part (e.g., the bow or handle) of the physical key.

The primary user or owner of the NFC-enabled physical key may define one or more restricted uses of the key to be monitored by the NFC based key control service. For example, the owner of the key may restrict others from making copies or duplicates of the physical key. The NFC reader in this example may be coupled to a key duplication device used by a retail key copying service or locksmith to make physical copies of a key by cutting a physical key blank in a pattern matching the original key. The NFC reader may be, for example, an integrated component of the key duplication device itself. Alternatively, the NFC reader may be implemented as a separate device physically attached to the key duplication device. The NFC reader/initiator device actively generates a near field, e.g., an electromagnetic or radio-frequency (RF) field that enables communications with the NFC tag of the physical key. Accordingly, the NFC reader of the key duplication device in this example can be used to detect an attempted use of the physical key when the NFC target of the key is located, e.g., physically placed by a third-party user (e.g., locksmith), within a predetermined proximity of the NFC reader and key duplication device based on, for example, the size of the near field region generated by the NFC reader.

In some implementations, the NFC reader of the key duplication device includes a network communication interface that enables a message including information related to an attempted use of the NFC-enabled key to be sent to a server hosting the key control service via a communication network. The server may be configured to determine whether or not the attempted use detected by the NFC reader is a restricted use of the physical key, e.g., as specified by a user who may be registered with the key control service as the primary user or owner of the key. If the server in this example were to determine that the attempted use is a restricted use, the server may be further configured to send a response message with instructions for the key duplication device to prevent duplication of the particular key NFC reader via the communication network. In this way, the key control and monitoring service enables the primary user or owner of the key to receive automatic notifications of unauthorized or restricted uses of the physical key.

While the examples provided herein are described in the context of monitoring and controlling attempted violations of a restriction on key duplication, it should be noted that the techniques described herein are not limited thereto and that these techniques may be used for monitoring and controlling attempted violations of other types of use restrictions may be monitored for one or more NFC-enabled keys. An example of another type of use restriction that may be defined for a NFC-enabled key includes, but is not limited to, a general use or access restriction that restricts usage of the key to a certain period of time (e.g., certain days or hours), as specified by the primary user or owner of the key. In this way, the owner of the key is able to control when the key may be used to gain access to physical property, e.g., a building or vehicle, owned or managed by the user. For example, attempted violations of such key use or access restrictions may be monitored using a specialized mechanical lock having an NFC reader/initiator, as described above. The NFC reader of the specialized lock may be configured to detect the NFC tag embedded within the physical key when, for example, the key and NFC tag are located within a predetermined proximity of the NFC reader of the mechanical lock, e.g., when the physical key is inserted into the key hole of the lock.

Reference now is made in detail to the examples illustrated in the accompanying drawings and discussed below. FIG. 1 illustrates an example communication network system 100 in which portions of the subject technology may be implemented. System 100 provides a variety of communication services, including the above-described NFC based key control service. As shown in FIG. 1, system 100 facilitates communications between various clients and servers via one or more interconnected networks including, but not limited to, a communication network 130, a private network 132 and the Internet 134. As will be described in further detail below, such communications include, but are not limited to, notifications of attempted violations of one or more key use restrictions for a primary user or owner of the key.

In the example shown in FIG. 1, client devices 110, 112 and 114 represent different types of computing devices configured to access mobile communication services, including the NFC based key control service, via a base station 120 of communication network 130. The user at each of client devices 110, 112 and 114 may be, for example, a primary user or owner of a physical key. Further, each of client devices 110, 112 and 114 may be configured to provide the user with notifications of attempted violations of use restrictions via an interface of the NFC based key control service executable at each device, as will be described in further detail below. Client device 110 may be, for example, a smart phone, tablet computer or similar type of mobile computing device having a touch-screen display and wireless capabilities for communicating with other devices and systems over communication network 130. Client device 112 may be, for example, a cellular device (e.g., a “feature phone”) that has a standard display without a touch-screen. However, like client device 110, client device 112 supports communications with other devices and systems over communication network 130. It should be noted that the subject technology is not intended to be limited to mobile devices and that such services also may be accessed using a desktop or personal computing device as represented by client device 114 of FIG. 1.

As shown in FIG. 1, communication network 130 facilitates communications between various types of clients (e.g., client devices 110, 112 and 114) and servers (e.g., servers 140, 142 and 144) of system 100. In addition, communication network 130 facilitates communications between any of the aforementioned computing devices and an NFC reader 162. As will be described in further detail below, NFC reader 162 may be used, for example, to detect attempted violations of a duplication restriction associated with an NFC-enabled key 152 having an embedded NFC tag or chip. In an example, NFC reader 162 may be coupled to a key duplication device used by a key cutting service or locksmith for copying physical keys. In this example, the NFC-enabled key 152 may be detected by NFC reader 262 when NFC-enabled key 152 (or NFC-tag embedded within the key 152) is positioned (e.g., by a third-party locksmith) within a predetermined proximity radius or near field 164 produced by NFC reader 262. Further, NFC reader 162 may report any attempted use of NFC-enabled key 152 to a server (e.g., server 140) hosting the NFC based key control service described herein via communication network 130, based on detection of NFC-enabled key 152 within near field 164. For example, server 140 may send a notification of an attempted use of NFC-enabled key 152 that has been restricted (e.g., attempted key duplication) via communication network 130 to one or more of client devices 110, 112 and 114 for display to an owner or primary user of NFC-enabled key 152 at the respective client device.

Communication network 130 may be, for example, a mobile communication network operated by a wireless carrier. Communication network 130 therefore may be implemented as, for example, a network conforming to various standards for public mobile wireless communications. Examples of such wireless communication standards include, but are not limited to, the code division multiple access (CDMA) standard, the 3rd Generation Partnership Project 2 (3GPP2) wireless IP network standard or the Evolution Data Optimized (EVDO) standard, the Global System for Mobile (GSM) communication standard, a time division multiple access (TDMA) standard.

Further, communication network 130 may include a number of radio access networks (RANs), as well as regional ground networks interconnecting a number of RANs and a wide area network (WAN) interconnecting the regional ground networks to core network elements. In some implementations, a regional portion of communication network 130 may be used to serve mobile client devices 110 and 112, can include one or more RANs and a regional circuit and/or packet switched network and associated signaling network facilities. Client devices 110 and 112 are capable of voice telephone communications through communication network 130. For the NFC based key control service described herein, client devices 110 and 112 in addition to client device 114 are capable of data communications through communication network 130 in accordance with the particular type(s) of wireless communication standard(s) associated with communication network 130.

In an example, communications related to the NFC based key control service, including notifications of attempted violations of key use restrictions, may be provided through communication network 130 as part of a data service offered by the wireless carrier and to which the user(s) of client devices 110, 112 and 114 may have subscribed. However, it should be noted that communication network 130 further supports communications for devices that do not participate in any particular service. The NFC based key control data service may be hosted at, for example, one or more of servers 140 or 142. As shown in FIG. 1, servers 140 and 142 are communicatively coupled to each other via a network 132. Network 132 may be, for example, a private data network of the wireless carrier that facilitates communications between servers 140 and 142 as well as other network devices operated by the carrier. Alternatively, the data service may be hosted at a third-party server 144 external to the carrier's network including, for example, communication network 130 and private network 132). As will be described in further detail below, a client application executable at each of client devices 110, 112 and 114 may be used to access the functionality of the data service and enable the user to control and monitor the usage of a physical key owned by the user through communication network 130.

The functionality of the NFC based key management service described herein may be provided for the benefit of a user of client device 110, 112 or 114 via a client application program, process, or interface (or simply “client”) that is executed on the device for enabling data communications with an associated application server through communication network 130. In an example, a user at client devices 110, 112 or 114 may access the functionality provided by NFC based key management service via a dedicated application program that is installed and executed at each device specifically for enabling the user to access the functionality provided by the NFC based key management service. In a different example, the functionality may be provided via a web interface using one or more web pages loaded within a web browser executable at the user's device.

The above-described application interface for accessing the functionality of the NFC based key control service can be configured to execute on many different types and configurations of computing devices. As such, client devices 110, 112 and 114 are intended to provide only a few examples of the types of client devices that may be used for providing an interface for the user to access the functionality of the automated key service. While the example in FIG. 1 shows only client devices 110, 112 and 114, system 100 may include additional devices (not shown) that are capable of communicating via communication network 130. In addition, system 100 can include other servers (not shown) in addition to servers 140, 142 and 144 as desired for a particular implementation. Furthermore, the techniques described herein may be implemented using any of a variety of available communication networks and/or on any type of computing device compatible with such a network.

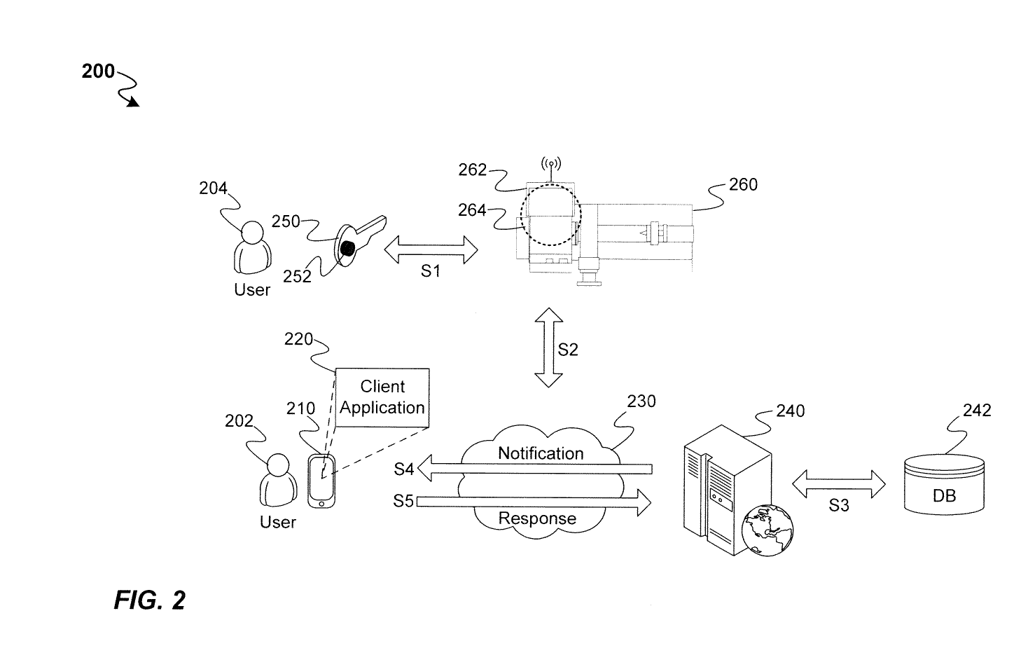

FIG. 2 is a block diagram illustrating an exemplary system 200 for automatically notifying a primary user or owner of an NFC-enabled key of an attempted violation of a restriction on duplication of the particular key. For purposes of discussion, system 200 will be described with reference to one or more of the components in system 100 of FIG. 1, as described above, but system 200 is not intended to be limited thereto. As shown in FIG. 2, system 200 includes a mobile device 210, an application or web server 240, a database 242, an NFC-enabled key 250 and a key duplication device 260. Key duplication device 260 includes an NFC reader 262 that is communicatively coupled to server 240 via a network 230. Server 240 in this example may be used to implement portions of the NFC based key control service described herein. As will be described in further detail below, server 240 enables automatic notifications of attempted violations of a duplication restriction for NFC-enabled key 250, e.g., as detected by NFC reader 262, to be sent via network 230 for display to a user 202 using an interface of the NFC based key control service provided within a client application 220 executable at the user's 202 mobile device 210.

Mobile device 210 can be any type of mobile computing device with at least one processor, a memory, a display and one or more user input devices (e.g., a touch-screen display, microphone, QWERTY keyboard or T9 keypad). Examples of such mobile computing devices include, but are not limited to, portable handsets, smart-phones, tablet computers and personal digital assistants. Mobile device 210 also may be implemented using, for example, client device 110 of system 100 of FIG. 1, as described above, but mobile device 210 is not intended to be limited thereto. As previously noted, the techniques described herein are not limited to mobile devices and the key control service interface may be provided using a client application executable at a workstation or desktop computing device (e.g., client device 114 of FIG. 1, as described above) of the primary user or owner of the key.

Server 240 can be any type of computing device having one or more processors, a memory and a communication interface capable of receiving and transmitting data over a network 230. Server 240 may be implemented using, for example, server 140 of FIG. 1, as described above. However, it should be noted that the operations performed by server 240 may occur at a single server device or may be distributed across multiple servers, for example, in a clustered computing environment or server farm.

Network 230 can be any network or combination of networks in an overall mobile communication network for transmitting data communications between various devices associated with the mobile communication network 230. Network 230 can include, but is not limited to, a wired (e.g., Ethernet) or a wireless (e.g., Wi-Fi, 3G or 4G) network. In addition, network 230 can include, but is not limited to, a local area network, medium area network, and/or wide area network such as the Internet. Network 230 can support any of various network communication protocols and standards including, but not limited to, Internet or World Wide Web protocols and communication standards. Network 230 may be implemented using, for example, one or more of networks 130, 132 and 134 of FIG. 1, as described above. Intermediate network devices including, for example, routers, gateway devices or other devices can be provided between the components of system 200 as may be desired when implementing the subject technology as described herein.

For purposes of the example shown in FIG. 2, user 202 is the owner of key 250, for which user 202 has specified a do-not-duplicate (or DND) restriction. User 204 is a third-party user, for example, a third-party locksmith or employee of a retail key cutting service, who may be a potential violator of the specified key use restriction. The DND restriction for key 250 may be, for example, one of various types of use restrictions that have been defined or selected by user 202 for the NFC-enabled key 250. In some implementations, user 202 may define various parameters for a particular use restriction that limit the restriction or in other words, authorize or restrict the particular use according to the defined parameters. Examples of such parameters or limits that may be defined for the DND restriction may include, but are not limited to, a time parameter for defining one or more time periods when the use restriction is to be enforced or the use permitted, a location parameter for restricting certain uses based on a predetermined geographic location of the physical key and a quantity parameter for limiting the number of times a physical key may be duplicated to a predetermined number.

In an example, NFC reader 262 may be preconfigured with its current geographic location, which may correspond to, for example, the physical location of the key duplication device 260 to which it is coupled. In some implementations, NFC reader 262 supports various types of wireless communication technologies or standards that may be used for purposes of determining location. Examples of such technologies or standards that may be used to determine location include, but are not limited to, Wi-Fi, cellular based on Cell-ID, and Global Positioning System (GPS). Further, NFC reader 262 may be configured to send its appropriate location to server 240. Server 240 can then determine whether or not use of key 250 at the particular location is allowed or restricted.

In a further example, database 242 stores the location and quantity information for key 250 in association with a service account associated with user 202, who may be, for example, registered with the key control service as the owner of key 250, as will be described in further detail below. The stored information for key 250 can be used by the NFC based key control service hosted at server 240 to track duplication restrictions for key 250 based on location or quantity. For example, server 240 can periodically update (e.g., by incrementing) a current value of stored counter variable for tracking the number of duplications or attempted duplications of key 250 detected by NFC reader 262 of key duplication device 260 or similar NFC reader of another key duplication device. Once the current value of the counter reaches the limit specified by the quantity parameter, any subsequent duplication is restricted and any attempted duplication would be treated as an attempted violation of the duplication restriction based on the quantity limit.

While the above examples are described using a single location parameter or a single quantity parameter, it should be noted that the techniques described herein are not limited thereto and that multiple location and/or quantity parameters corresponding to different locksmiths or retail key cutting services may be used. In an example, the owner/user of key 250 may allow duplication of key 250 up to a user-specified quantity limit and only at user-selected retail key cutting service locations. In a further example, the owner of key 250 may specify different quantity limits for different key cutting service locations, as desired by the owner. In this way, the NFC based key control service enables an owner of an NFC-enabled key (e.g., key 250) to selectively control how a DND restriction is applied with respect to individual locksmiths or key cutting services.

As described above, user 202 may be registered with the NFC based key control service hosted at server 240 as being the owner of key 250. In some implementations, the unique key identifier may be a NFC or Radio-Frequency Identification (RFID) tag identifier associated with NFC tag 252. Further, the generated key identifier for key 250 and any restricted uses of key 250, as defined by user 202, may be stored within database 242 for later access by server 240 in implementing the functionality of the NFC based key control service. The generated key identifier may be stored, for example, in association with a user or account identifier associated with a service account of user 202.

In a further example, the NFC-enabled key 250 may have been assigned a unique identifier by the manufacturer or service provider, for example, when the key 250 was originally issued to the user or current owner. In this case, the unique identifier may be permanently assigned to the key 250 and stored in a read-only (write-once) memory of the NFC tag 252 embedded within the key 250. Alternatively, the unique identifier may have been assigned to the key by the service provider during an activation process initiated by the user upon purchasing the NFC-enabled key 250. Such an activation process may include, for example and without limitation, generating a unique identifier for the specific key 250 and initializing the embedded NFC tag 252. The initialization of the embedded NFC 252 may include, for example, storing the generated unique identifier within the NFC tag's 252 memory and registering the initialized NFC-enabled key 250 for an account of the user with the NFC-enabled key control service.

In an example, the service provider is a wireless carrier or operator of network 230 implemented as, for example, a mobile communication network for providing the NFC based key control service along with various other mobile communication services to user 202 via network 230. The unique key identifier in this example may be, for example, carrier-specific identifier that may be used to identify the particular NFC tag 252 embedded within key 250. The user or account identifier may be, for example, a mobile device identifier or mobile directory number (MDN) associated with mobile device 210. In some implementations, an interface for accessing the functionality of the NFC based key control service is provided to user 202 through a client application 220 executable at mobile device 210. Client application 220 may include, for example, an interface for initiating the above-described registration process for registering key 250 and one or more other physical keys having embedded NFC tags that are owned by user 202.

Key duplication device 260 may be any machine or apparatus that can be used to make physical copies or duplicates of key 250 by, for example, cutting a key blank according to a specific pattern that matches the notches on a blade portion of key 250. As noted above, key duplication device 260 in this example is equipped with NFC reader 262. In some implementations, NFC reader 262 is an integrated component within key duplication device 260. Alternatively, NFC reader 262 may be a separate device attached to a portion of key duplication device 260.

In the example shown in FIG. 2, NFC reader 262 actively generates a near field 264 used to initiate wireless communications with the NFC tag 252 embedded within the physical key 250, when the NFC-enabled key 250 (or NFC tag 252) is located (e.g., positioned by user 204) within a predetermined proximity radius of NFC reader 262. The predetermined proximity radius may be defined by, for example, the size of the near field 264 actively generated by NFC reader 262. The near field 264 may be, for example, an electromagnetic field generated by NFC reader 262 covering a region of space that surrounds the NFC reader 262 and a corresponding portion of key duplication device 260. For example, NFC reader 262 may be physically located in a part of key duplication device 260 such that the generated near field 264 covers a region of space surrounding a mechanical key holder (e.g., a clamp or vise) of key duplication device 260 generally used to hold a key being duplicated in place while duplicating the key, e.g., by cutting or grinding a key blank in a pattern matching the key.

NFC tag 252 may be, for example, a passive NFC target embedded within the physical key 250. As such a passive NFC target generally does not include its own power source, NFC tag 252 may draw power directly from the electromagnetic energy of the near field 264 generated by NFC reader 262. However, it should be noted that the techniques described herein are not limited to passive NFC targets and that NFC tag 252 may be implemented as an active NFC target that has a power supply (e.g., a battery) and is capable of actively generating its own near (or RF) field and operating in an active communication mode for communications with NFC reader 262 or other NFC-enabled devices. Further, the NFC tag 252 embedded within key 250 may be implemented using any of various types of NFC tags including, for example, tag types conforming to industry standards specified by a NFC standards setting organization (e.g., the NFC Forum).

When the NFC tag 252 of key 250 is within the predetermined proximity radius or operational range of NFC reader 262 corresponding to near field 264, NFC reader 262 is configured to read data stored within the NFC tag 252 (at S1). The unique key identifier may be stored in, for example, a memory of NFC tag 252. In addition to the unique key identifier, this memory may be used to store additional data, for example, data related to the owner or primary user of the key 250 (user 202 in this example) or subscriber account associated with such user. Such additional data may include, for example and without limitation, a unique identifier associated with user 202 or the user's 202 subscriber account. However, it would be apparent given this description that the size of the memory of the NFC tag 252 may be limited to a predetermined size based on, for example, the particular type of the NFC tag 252. Accordingly, the amount of data that may be stored within NFC tag 252 also may be limited to predetermined amount based on the size of the memory. In some implementations, the data stored within the memory of NFC tag 252 includes a flag to indicate whether or not any use restrictions have been defined for the NFC-enabled key 250, e.g., by user 202 during the aforementioned registration process. A benefit of using such a flag may include allowing NFC reader 262 to quickly determine whether or not to perform any operations related to the NFC based key control service described herein. Such operations may include, for example, preventing the duplication of key 250 by key duplication device 260.

Upon obtaining the unique key identifier for key 250 from NFC tag 252, NFC reader 262 sends via network 230 a request message indicating to server 240 (at S2) that an attempted use of key 250 with key duplication device 260 has been detected by NFC reader 262. The message sent by NFC reader 262 includes, but is not limited to, the unique key identifier for key 250. In some implementations, the message may also include additional information related to, for example, the attempted duplication of the NFC-enabled key 250. Such additional information may include, for example and without limitation, information related to the time or location of the attempted violation of the duplication restriction, as detected by NFC reader 262 at the key duplication device 260.

Server 240 use the information included within the request to identify the owner or primary user (user 202 in this example) of key 250. As described above, the unique key identifier for key 250 may be stored in association with a user or account identifier for a service account of user 202. In some implementations, this information may be stored in database 242. Accordingly, server 240 can use the unique key identifier of key 250 to query database 242 to retrieve information related to the subscriber account or identity of the owner/primary user of key 250 (at S3). The stored account information may also include use restrictions defined for the NFC-enabled key 250 by, for example, user 202 during the above-described key activation or registration process. Thus, server 240 can use the information retrieved from database 242 for user 202 or subscriber account thereof to determine whether or not the attempted duplication of the NFC-enabled key 250 qualifies as a restricted use of key 250.

If server 240 determines that the attempted duplication of key 250 has been restricted, server 240 sends a notification of the restricted use to mobile device 210 of user 202 via network 230 (at S4). The notification may be in the form of, for example, a Short Message Service (SMS) message. However, the present disclosure is not intended to be limited to SMS messages and the notification may be sent using any of various messaging services supported by mobile device 210. Further, server 240 may include additional information related to, for example, the time or location of the attempted duplication of key 250, as described above, along with the notification sent to the user's 202 mobile device 210 in this example.

In some implementations, server 240 is configured to send such notifications for display to user 202 via a client application 220 executable at mobile device 210. Client application 220 may serve as, for example, an interface of the NFC based key control service for user 202 at mobile device 210. Client application 220 may be, for example, a web browser and thus, the interface provided to user 202 at device 210 may be a web interface in a web page loaded within the web browser. The notification from server 240 is displayed to user 202 via a display of mobile device 210. The notification may be a visual notification in the form of, for example, a pop-up or dialog window including a message alerting user 202 of the restricted use, e.g., the attempted violation of the duplication restriction defined for key 250.

In a further example, client application 220 may provide user 202 with an option to modify or remove the use restriction for the particular key 250. As shown in FIG. 2, client application 220 may send a response message indicating the user-selected option to remove the existing use restriction (e.g., duplication restriction) for key 250 to server 240 via network 230 (at S5). For example, the user may override an existing restriction via the client application 220 executable at mobile device 210 either beforehand or in response to the received notification of the attempted violation. Server 240 in turn updates the use restriction(s) for key 250 accordingly. In some implementations, server 240 is configured to track attempted violations, for example, by maintaining a log of violations. Server 240 may be further configured to notify the appropriate authorities at predetermined time intervals or after a predetermined number of attempted duplications have been detected for a particular locksmith or key cutting service.

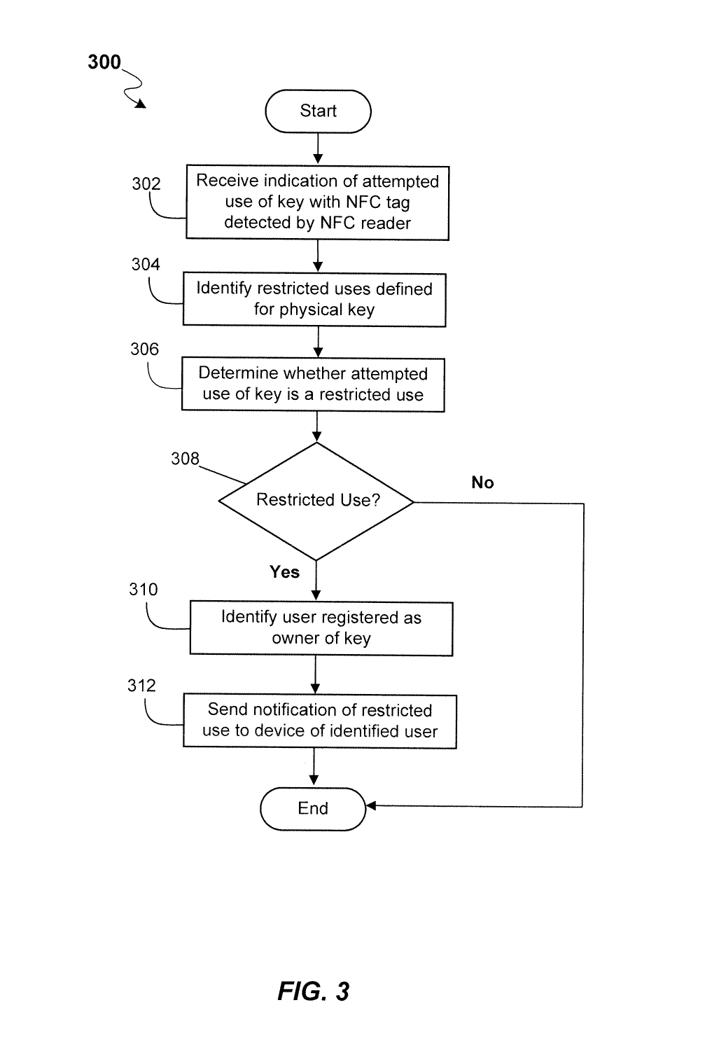

Additional examples and description related to these techniques including, for example, operations of mobile device 210 and/or server 240, are provided below with respect to the example method illustrated in FIG. 3.

FIG. 3 is a process flowchart of an example method 300 for automatically notifying a primary user or owner of an NFC-enabled key of an attempted violation of a key use restriction. For purposes of discussion, method 300 will be described using system 200 of FIG. 2, as described above, but method 300 is not intended to be limited thereto. Further, method 300 will be described in the context of a client application program (e.g., client application 220 of system 200) executed at a mobile device (e.g., mobile device 210 of system 200). The mobile device is communicatively coupled to a server (e.g., server 240) via a network (e.g., network 230 of system 200). Thus, the steps of method 300 may be performed by, for example, server 240 of system 200 of FIG. 2, as described above.

Method 300 begins in step 302, which includes receiving an indication of an attempted use of a NFC-enabled key with an embedded NFC tag via the network. The indication may be provided in a message received from an NFC reader device coupled to, for example, a key duplication device (e.g., key duplication device 260 of FIG. 2, as described above). The message from the NFC reader may include, for example, a unique identifier associated with the particular NFC-enabled key in this example. As described above, the unique identifier associated with the key may be stored within the NFC tag embedded within the key. The unique identifier for the NFC-enabled key may be associated with an account identifier associated with the primary user/owner of the key. The user's account information, including information related to the NFC-enabled key registered to the user, may be stored in a database or centralized repository accessible to a server hosting the NFC based key control service via the network. In an example, the network is a mobile communication network operated by a wireless carrier. The wireless carrier may provide various mobile communication services along with the NFC based key control service described herein to a mobile device of the user.

Method 300 then proceeds to step 304, which includes identifying one or more restricted uses of the NFC-enabled physical key. As described above, the primary user or owner of the physical key may define one or more restricted uses of the key. For example, the owner of the key may restrict others from making copies or duplicates of the physical key. As described above, an NFC reader in this example may be coupled to a key duplication device used by a retail key copying service or locksmith in order to detect an attempted use of the physical key for a particular purpose, e.g., duplication of the key. The attempted use of the key may be detected by the NFC reader when, for example, the NFC target of the key is located or physically positioned within a predetermined proximity of the NFC reader and key duplication device. The predetermined proximity may be based on, for example, the size of a near field generated by the NFC reader, as described above.

At steps 306 and 308, it is determined whether or not the attempted use, as indicated by the message received at step 302, is a restricted use of the NFC-enabled key, as identified in step 304. If the attempted use is determined not to be a restricted use at step 308, method 300 concludes. However, if the attempted use is determined to be a restricted use, method 300 proceeds to step 310. Step 310 includes identifying the registered owner or primary user of the NFC-enabled key. The registered owner/user may be identified based on, for example, the unique key identifier associated with the NFC-enabled key. As previously described, the unique key identifier may be stored in association with other account information for a service account of the particular user or registered owner or service account thereof. In some implementations, a look-up table may be used to quickly find account information for the user's account based on the unique key identifier. Once the registered owner of the key has been identified, method 300 proceeds to step 312, which includes sending a notification of the restricted use to a computing device associated with the identified user.

Although not shown in FIG. 3, method 300 may include additional steps including, but not limited to, sending instructions from a server (e.g., server 240 of FIG. 2, as described above) hosting the key control service via the network to the NFC reader for preventing duplication of the particular key for which duplication has been restricted. For example, the key duplication device may be specially adapted to disable its key pattern grinder or key cutting mechanism for the specific key based on a control signal generated by the NFC reader. The NFC reader generates such a control signal for disabling the key duplication functionality of the key duplication device in accordance with the instructions it receives through the network from the server hosting the key control service.

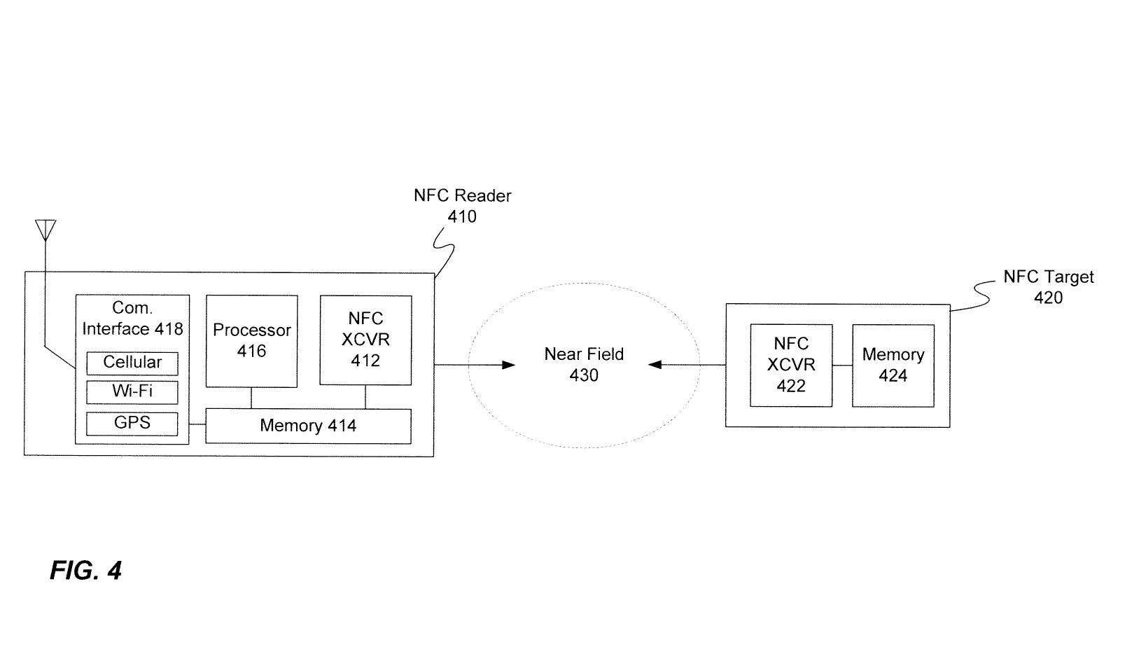

FIG. 4 illustrates an exemplary NFC reader 410 communicatively coupled to an exemplary NFC target 420 via a near field 430. As shown in FIG. 4, NFC reader 410 includes an NFC transceiver (or “XCVR”) 412, a memory 414, a processor 416 and a communication interface 418. NFC target 420 includes an NFC transceiver 422 and a memory 424. Although not shown in FIG. 4, it should be noted that each of NFC reader 410 and NFC target 420 may include additional components as desired for a particular implementation. In this example, NFC reader 410 may be implemented as, for example, an active NFC reader or initiator device and NFC target 420 may be implemented as, for example, a passive NFC target. Referring back to the example system 200 of FIG. 2, NFC reader 410 may be used to implement, for example, NFC reader 262 of FIG. 2, as described above. Similarly, NFC target 420 may be used to implement the NFC tag 252 embedded within the physical key 250 of FIG. 2, as described above. However, as previously noted, the present disclosure is not intended to be limited to passive NFC targets. Thus, in a different example, both NFC reader 410 and NFC target 420 may be NFC devices capable of producing their own respective near fields and operating in an active communication mode for communicating with other NFC devices.

NFC reader 410 uses NFC transceiver 412 to actively generate near field 430. As described above, near field 430 may be an electromagnetic field used to power the passive NFC target 420, including NFC transceiver 422 and memory 424. As such, NFC transceiver 422 operates in a passive communication mode, thereby enabling NFC transceiver 412 of NFC reader 410 to perform a read operations with respect to the data stored in memory 424 of NFC target 420. The communications between NFC reader 410 and NFC target 420 are enabled when, for example, NFC target 420 is located within a predetermined proximity of NFC reader 410 according to the size of near field 430.

As shown in the example of FIG. 4, processor 416 of NFC reader 410 serves as a programmable controller for NFC reader 410. Processor 416 is configured to control all operations of NFC reader 410 including any operations associated with the NFC based key control service described herein, e.g., operations performed by NFC reader 262 of FIG. 2, as described above. Further, processor 416 performs any operations in accordance with programming associated with such key control service in addition to other standard operations in general for the device. Memory 414 may be implemented using any processor-readable storage medium. Memory 414 may be used to store programming used to configure processor 416 to perform various desired functions, including functions related to the NFC based key control service described herein.

As previously described, the key control service may be provided by, for example, a wireless carrier or operator of a mobile communication network. Hence, the communication interface 418 of NFC reader 410 may be configured for wireless communications across the mobile communication network. In some implementations, communication interface 418 includes a cellular analog or digital transceiver compatible with the particular type of mobile communication network. Further, communication interface 418 may support any of various wireless communication standards and protocols supported by the mobile communication network. As shown in FIG. 4, communication interface 418 may also provide support for other types wireless communication standards and technologies including, for example, Wi-Fi and Global Positioning Systems (GPS). Although not shown in FIG. 4, communication interface 418 may also provide support for other types of wireless communication standards including, but not limited to, Bluetooth.

A general-purpose computer used for data processing and communications applications, typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data, e.g. files used for identifying a particular hardware accessory or mobile device, as described herein. The software code is executable by the general-purpose computer. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for automatically determining the compatibility of a hardware accessory product with the user's device, in essentially the manner performed in the implementations discussed and illustrated herein.

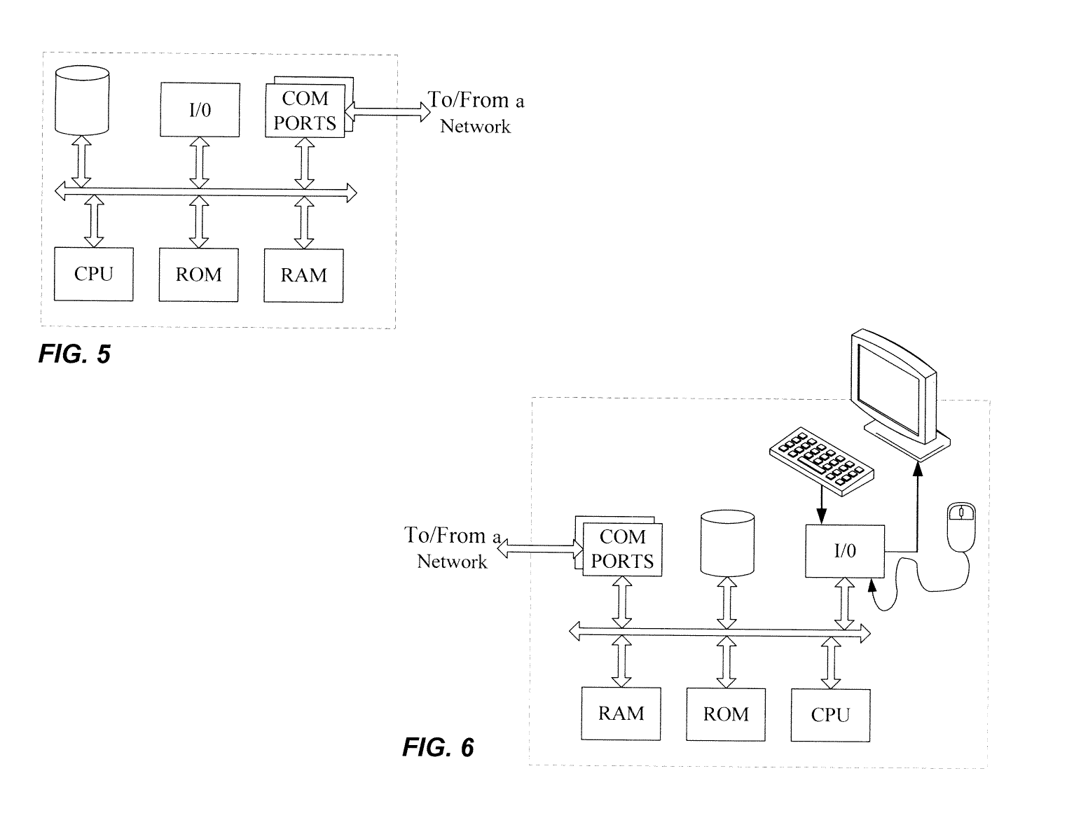

FIGS. 5 and 6 are functional block diagrams illustrating general purpose computer hardware platforms. FIG. 5 illustrates a network or host computer platform, as may typically be used to implement a server (e.g., any of servers 140, 142 or 144 of FIG. 1 or server 240 of FIG. 2, as described above). FIG. 6 depicts a computer with user interface elements, as may be used to implement a personal computer or mobile device (e.g., mobile device 110 of FIG. 1 or mobile device 210 of FIG. 2, as described above). It is believed that the structure, programming and general operation of such computer equipment and as a result the drawings should be self-explanatory.

A server, for example, includes a data communication interface for packet data communication. The server also includes a central processing unit (CPU), in the form of one or more processors, for executing program instructions. The server platform typically includes an internal communication bus, program storage and data storage for various data files to be processed and/or communicated by the server, although the server often receives programming and data via network communications. The hardware elements, operating systems and programming languages of such servers are conventional in nature. Of course, the server functions may be implemented in a distributed fashion on a number of similar platforms, to distribute the processing load.

Hence, the steps of the method 300 of FIG. 3, as described above, may be embodied in programming. Program aspects of the technology may be thought of as “products” or “articles of manufacture” typically in the form of executable code or process instructions and/or associated data that is stored on or embodied in a type of machine readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of a web service provider into the computer platform of the application or web server that will be hosting the web service.

Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible storage media, terms such as “computer’ or “machine readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the steps of method 300 of FIG. 3, as described above. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

As noted above, the computer as illustrated in the example of FIG. 7 may be a mobile computer with user interface elements, as may be used to implement a laptop, tablet or notebook computer or the like. For example, such a device may include a touch-screen display for user input and output. Alternatively, the device may include a standard light emitting diode (LED) display and, for example, an alphanumeric keypad or T9 keyboard. It is believed that the structure, programming, and general operation of such computing equipment and as a result the drawing should be self-explanatory. As known in the data processing and communications arts, a mobile computer comprises a central processor or other processing device, an internal communication bus, various types of memory or storage media (RAM, ROM, EEPROM, cache memory, disk drives, etc.) for code and data storage, and one or more network interface cards or ports for communication purposes. Also, the mobile computer can further comprise various wireless transceiver modules (or components) such as GPS, WiFi, IrDA, Bluetooth, etc. The software functionalities involve programming, including executable code, associated stored data, and graphical user interface code for implementing a client application program at the mobile device. The software code is executable by the processor of the mobile computer. In operation, the code is stored within the mobile computer. At other times, however, the software may be stored at other locations and/or transported for loading into the appropriate mobile computer. Execution of such code by a processor of the mobile computer enables the mobile computer to implement the methodology for a client for requesting access to one or more functions offered by a web service, in essentially the manner performed in the implementation discussed and illustrated herein.

Further, the client can be implemented in a remote computer (or server) on a network. That is, a mobile device sends information (e.g., a request message, including a security token) to the remote server for requesting access to a function of an NFC based key control service hosted at the server; and the remote server processes the request based on the security token for the client and returns an appropriate response to the mobile device over the network. In the example above, the mobile device operates as a client terminal and the remote computer as a server in a client-server network environment. While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer system, comprising:
a communication interface configured to enable communication through a network;
a processor coupled to the interface;
a memory accessible to the processor; and
programming stored in the memory, wherein execution of the programming by the processor configures the computer system to perform functions, including functions to:
receive, via the network and the communication interface from a first communication device, a message indicating an attempted use of a physical key equipped with a second communication device that is configured to communicate with the first communication device when the second communication device is within a predetermined proximity of the first communication device, the message including information identifying the physical key and information related to the attempted use detected by the first device;
determine whether or not the attempted use of the physical key has been restricted by a primary user or owner of the physical key, based on the information included within the received message; and
when the attempted use is determined to be a restricted use of the physical key, transmitting, to a computing device of the primary user via the network, a message notifying the primary user or owner of the restricted use.

2. The computer system of claim 1, wherein the processor further configures the computer system to perform functions to:
send, to the first communication device via the network, a message instructing the first communication device to prevent the restricted use of the physical key, when the attempted use is determined to be a restricted use of the physical key.

3. The computer system of claim 1, wherein the notification message transmitted to the primary user includes a time when the restricted use of the physical key was detected by the first communication device and a location of the restricted use of the physical key, as detected by the first communication device.

4. The computer system of claim 1, wherein the first communication device is a near field communication (NFC) reader and the second communication device is an NFC target embedded within the physical key.

5. The computer system of claim 4, wherein the information identifying the NFC target includes a unique identifier associated with the physical key, and stored within the NFC target.

6. The computer system of claim 4, wherein the network is a mobile communication network operated by a wireless carrier and the unique identifier associated with the physical key is stored in association with a service account of the user for communication services provided to the user by the wireless carrier via the mobile communication network.

7. The computer system of claim 4, wherein the physical key operates a mechanical lock for accessing an item of physical property owned by the primary user or owner, and the restricted use is an access restriction defined by the primary user or owner for the physical property.

8. The computer system of claim 4, wherein the NFC reader is coupled to a key duplication device, and the restricted use is a restriction on duplication of the physical key.

9. The computer system of claim 8, wherein parameters limiting the restriction on duplication of the physical key are defined by the primary user or owner of the physical key.

10. The computer system of claim 9, wherein the parameters limiting the restriction on duplication of the physical key include a time parameter, a location parameter and a quantity parameter.

11. A computer-implemented method, comprising:
receiving, at a server via a network from a first communication device, a message indicating an attempted use of a physical key equipped with a second communication device that is configured to communicate with the first communication device when the second communication device is within a predetermined proximity of the first communication device, the message including information identifying the physical key and information related to the attempted use detected by the first device;
determining whether or not the attempted use of the physical key has been restricted by a primary user or owner of the physical key, based on the information included within the received message; and
when the attempted use is determined to be a restricted use of the physical key, transmitting, to a computing device of the primary user or owner via the network, a message notifying the primary user of the restricted use.

12. The method of claim 11, further comprising:
sending, to the first communication device via the network, a message instructing the first communication device to prevent the restricted use of the physical key, when the attempted use is determined to be a restricted use of the physical key.

13. The method of claim 11, wherein the notification message transmitted to the primary user includes a time when the restricted use of the physical key was detected by the first communication device and a location of the restricted use of the physical key, as detected by the first communication device.

14. The method of claim 11, wherein the first communication device is a near field communication (NFC) reader and the second communication device is an NFC target embedded within the physical key.

15. The method of claim 14, wherein the information identifying the NFC target includes a unique identifier associated with the physical key, and stored within the NFC target.

16. The method of claim 14, wherein the network is a mobile communication network operated by a wireless carrier and the unique identifier associated with the physical key is stored in association with a service account of the user for communication services provided to the user by the wireless carrier via the mobile communication network.

17. The method of claim 14, wherein the physical key operates a mechanical lock for accessing an item of physical property owned by the primary user or owner, and the restricted use is an access restriction defined by the primary user or owner for the physical property.

18. The method of claim 14, wherein the NFC reader is coupled to a key duplication device, and the restricted use is a restriction on duplication of the physical key.

19. The method of claim 18, wherein parameters limiting the restriction on duplication of the physical key are defined by the primary user or owner of the physical key.

20. The method of claim 19, wherein the parameters limiting the restriction on duplication of the physical key include a time parameter, a location parameter and a quantity parameter.
